(19) United States
(12) Patent Application Publication
(10) Pub. No.: US 2012/0029122 A1
(43) Pub. Date: Feb. 2, 2012

(54) FLAME RETARDANT MOLDING COMPOSITIONS

(75) Inventors: Siqi Xue, Shanghai (CN); Sabine Fuchs, Mannheim (DE)

(73) Assignee: BASF SE, Ludwigshafen (DE)

(21) Appl. No.: 13/193,886

(22) Filed: Jul. 29, 2011

Related U.S. Application Data
(60) Provisional application No. 61/369,096, filed on Jul. 30, 2010.

(51) Int. Cl. C08K 5/3492; C08K 3/30; C08K 5/53

(52) U.S. Cl. 524/100; 524/133; 524/420

(57) ABSTRACT

Thermoplastic molding compositions, comprising
A) from 10 to 98% by weight of a thermoplastic polymer,
B) from 0.5 to 40% by weight of a flame retardant compound comprising phosphorus,
C) from 0.5 to 35% by weight of iron sulfide,
D) from 0 to 70% by weight of further additives,
   where the total of the percentages by weight of components A) to D) is 100%.

### CROSS-REFERENCE TO RELATED APPLICATIONS

This application claims benefit (under 35 USC 119(e)) of U.S. Provisional Application 61/369,096, filed Jul. 30, 2010 which is incorporated by reference.

### BACKGROUND OF THE INVENTION

The invention relates to thermoplastic molding compositions, comprising
A) from 10 to 98% by weight of a thermoplastic polymer,
B) from 0.5 to 40% by weight of a flame retardant compound comprising phosphorus,
C) from 0.5 to 35% by weight of iron sulfide,
D) from 0 to 70% by weight of further additives,
   where the total of the percentages by weight of components A) to D) is 100%.

The invention further relates to the use of the molding compositions of the invention for producing fibers, foils, and moldings of any type, and also to the resultant moldings.

Thermoplastic polyamides such as PA6 and PA66 are often used in the form of glassfiber-reinforced molding compositions as structural materials for components which have exposure to elevated temperatures during their life time.

Many applications in the electrical and electronic sector require flame-retardant modification, compounds used here being inter alia those comprising phosphorus.

The use of red phosphorus as conventional flame retardant is known by way of example from DE-A 39 05 038, DE-A 41 00 740, and DE-A 1 96 48 503, where red phosphorus is mostly combined with reinforcing materials, in particular glass fibers, in order to obtain the necessary mechanical properties. However, glass fibers exhibit what is known as the wicking effect, i.e. addition of fibers has a considerable adverse effect on fire classification.

From an environmental point of view, it is desirable to find a replacement for compounded materials that comprise halogen.

For PVC, there is a known flame retardant combination made of metal hydroxides and iron sulfide (pyrite), see JP-A 54/114558.

However, the content of the stated amounts of metal hydroxides has a disadvantageous effect on the mechanical properties of the molding compositions.

### BRIEF SUMMARY OF THE INVENTION

The invention relates to a thermoplastic molding composition, comprising
A) from 10 to 98% by weight of a thermoplastic polymer,
B) from 0.5 to 40% by weight of a flame retardant compound comprising phosphorus,
C) from 0.5 to 35% by weight of iron sulfide,
D) from 0 to 70% by weight of further additives,
   where the total of the percentages by weight of components A) to D) does not exceed 100%.

It was therefore an object of the present invention to provide flame-retardant thermoplastics which are to be halogen-free and are to have the mechanical and flame-retardancy properties that are required for most applications.

### DETAILED DESCRIPTION OF THE INVENTION

The molding compositions defined in the introduction have accordingly been found. Preferred embodiments can be found in the dependent claims.

Surprisingly, the combination of flame retardants comprising phosphorus with iron sulfide gives UL 94 V-0 classification and an improved LOI value, and also higher phosphorus stability.

In principle, the advantageous effect is apparent with the molding compositions of the invention when using thermoplastics of any type. A list of suitable thermoplastics is found by way of example in Kunststoff-Taschenbuch [Plastics Handbook] (ed. Saechtling), 1989 edition, which also gives sources. Processes for producing these thermoplastics are known per se to the person skilled in the art.

Preferred thermoplastics are those selected from the group of the polyamides, polyesters, polycarbonates, vinylaromatic polymers, ASA polymers, ABS polymers, SAN polymers, POM, PPE, and polyarylene ether sulfones, preference being given to polyamides, polyesters, and polycarbonates.

Preferred thermoplastics are those selected from the group of the polyamides, polyesters, polycarbonates, vinylaromatic polymers, ASA polymers, ABS polymers, SAN polymers, POM, PPE, and polyarylene ether sulfones, preference being given to polyamides, polyesters, and polycarbonates.

The molding compositions of the invention comprise, as component (A), from 10 to 98% by weight, preferably from 20 to 97% by weight, and in particular from 30 to 95% by weight, of at least one thermoplastic polymer, preferably polyesters/polycarbonates.

Use is generally made of polyesters A) based on aromatic dicarboxylic acids and on an aliphatic or aromatic dihydroxy compound.

A first group of preferred polyesters is that of polyalkylene terephthalates having in particular from 2 to 10 carbon atoms in the alcohol moiety.

Polyalkylene terephthalates of this type are known per se and are described in the literature. Their main chain comprises an aromatic ring which derives from the aromatic dicarboxylic acid. There may also be substitution in the aromatic ring, e.g. by halogen, such as chlorine or bromine, or by C₁-C₄-alkyl, such as methyl, ethyl, iso- or n-propyl, or n-, iso- or tert-butyl groups.

These polyalkylene terephthalates may be produced by reacting aromatic dicarboxylic acids, or their esters or other ester-forming derivatives, with aliphatic dihydroxy compounds in a manner known per se.

Preferred dicarboxylic acids are 2,6-naphthalenedicarboxylic acid, terephthalic acid and isophthalic acid or mixtures of these. Up to 30 mol %, preferably not more than 10 mol %, of the aromatic dicarboxylic acids may be replaced by aliphatic or cycloaliphatic dicarboxylic acids, such as adipic acid, azelaic acid, sebacic acid, dodecanedioic acids and cyclohexanedicarboxylic acids.

Preferred aliphatic dihydroxy compounds are diols having from 2 to 6 carbon atoms, in particular 1,2-ethanediol, 1,3-propanediol, 1,4-butanediol, 1,6-hexanediol, 1,4-hexanediol, 1,4-cyclohexanediol, 1,4-cyclohexanedimethanol and neopentyl glycol, and mixtures of these.

Particularly preferred polyesters (A) are polyalkylene terephthalates derived from alkanediols having from 2 to 6 carbon atoms. Among these, particular preference is given to polyethylene terephthalate, polypropylene terephthalate and polybutylene terephthalate, and mixtures of these. Preference is also given to PET and/or PBT which comprise, as other monomer units, up to 1% by weight, preferably up to 0.75% by weight, of 1,6-hexanediol and/or 2-methyl-1,5-pentanediol.

The intrinsic viscosity of the polyesters (A) is generally in the range from 50 to 220, preferably from 80 to 160 (measured in 0.5% strength by weight solution in a phenol/o-dichlorobenzene mixture in a ratio by weight of 1:1) at 25° C. to ISO 1628.

Particular preference is given to polyesters whose carboxy end group content is up to 100 meq/kg of polyester, preferably up to 50 meq/kg of polyester and in particular up to 40 meq/kg of polyester. Polyesters of this type may be produced, for example, by the process of DE-A 44 01 055. The carboxy end group content is usually determined by titration methods (e.g. potentiometry).

Particularly preferred molding compositions comprise, as component A), a mixture of polyesters other than PBT, an example being polyethylene terephthalate (PET). An example of the proportion of the polyethylene terephthalate in the mixture is preferably up to 50% by weight, in particular from 10 to 35% by weight, based on 100% by weight of A).

It is also advantageous to use PET recyclates (also termed scrap PET) optionally in a mixture with polyalkylene terephthalates, such as PBT.

Recyclates are generally:
1) those known as post-industrial recyclates: these are production wastes during polycondensation or during processing, e.g. sprues from injection molding, start-up material from injection molding or extrusion, or edge trims from extruded sheets or films.
2) post-consumer recyclates: these are plastics items which are collected and treated after utilization by the end consumer. Blow-molded PET bottles for mineral water, soft drinks and juices are easily the predominant items in terms of quantity.

Both types of recyclate may be used either as regrind or in the form of pellets. In the latter case, the crude recycled materials are isolated and purified and then melted and pelletized using an extruder. This usually facilitates handling and free-flowing properties, and metering capability for further steps in processing.

The recycled materials used may either be pelletized or in the form of regrind. The edge length should not be more than 10 mm and should preferably be less than 8 mm.

Because polyesters undergo hydrolytic cleavage during processing (due to traces of moisture) it is advisable to predry the recycled material. Residual moisture content after drying is preferably <0.2%, in particular <0.05%.

Another class to be mentioned is that of fully aromatic polyesters deriving from aromatic dicarboxylic acids and aromatic dihydroxy compounds.

Suitable aromatic dicarboxylic acids are the compounds previously described for the polyalkylene terephthalates. The mixtures preferably used are made from 5 to 100 mol % of isophthalic acid and from 0 to 95 mol % of terephthalic acid, in particular from about 50 to about 80% of terephthalic acid and from 20 to about 50% of isophthalic acid.

The aromatic dihydroxy compounds preferably have the general formula

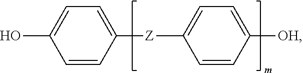

in which Z is an alkylene or cycloalkylene group having up to 8 carbon atoms, an arylene group having up to 12 carbon atoms, a carbonyl group, a sulfonyl group, an oxygen atom or sulfur atom, or a chemical bond, and in which m has the value from 0 to 2. The phenylene groups in the compounds may also have substitution by C₁-C₆-alkyl groups or alkoxy groups, and fluorine, chlorine, or bromine.

Examples of parent compounds for these compounds are
dihydroxybiphenyl,
di(hydroxyphenyl)alkane,
di(hydroxyphenyl)cycloalkane,
di(hydroxyphenyl)sulfide,
di(hydroxyphenyl)ether,
di(hydroxyphenyl)ketone,
di(hydroxyphenyl)sulfoxide,
α,α′-di(hydroxyphenyl)dialkylbenzene,
di(hydroxyphenyl)sulfone, di(hydroxybenzoyl)benzene,
resorcinol, and hydroquinone, and also the ring-alkylated and ring-halogenated derivatives of these.

Among these, preference is given to
4,4′-dihydroxydiphenyl,
2,4-di(4′-hydroxyphenyl)-2-methylbutane,
α,α′-di(4-hydroxyphenyl)-p-diisopropylbenzene,
2,2-di(3′-methyl-4′-hydroxyphenyl)propane, and
2,2-di(3′-chloro-4′-hydroxyphenyl)propane,
   and in particular to
2,2-di(4′-hydroxyphenyl)propane,
2,2-di(3′,5-dichlorodihydroxyphenyl)propane,
1,1-di(4′-hydroxyphenyl)cyclohexane,
3,4′-dihydroxybenzophenone,
4,4′-dihydroxydiphenyl sulfone and
2,2-di(3′,5′-dimethyl-4′-hydroxyphenyl)propane
   or a mixture of these.

It is, of course, also possible to use mixtures of polyalkylene terephthalates and fully aromatic polyesters. These generally comprise from 20 to 98% by weight of the polyalkylene terephthalate and from 2 to 80% by weight of the fully aromatic polyester.

It is, of course, also possible to use polyester block copolymers, such as copolyetheresters. Products of this type are known per se and are described in the literature, e.g. in U.S. Pat. No. 3,651,014. Corresponding products are also available commercially, e.g. Hytrel® (DuPont).

Halogen-free polycarbonates are also understood to be polyesters in the invention. Examples of suitable halogen-free polycarbonates are those based on biphenols of the general formula

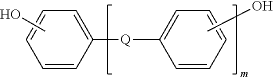

in which Q is a single bond, a C₁-C₈-alkylene group, a C₂-C₃-alkylidene group, a C₃-C₆-cyclo-alkylidene group, a C₆-C₁₂-arylene group, or else —O—, —S— or —SO₂—, and m is a integer from 0 to 2.

The phenylene radicals of the biphenols may also have substituents, such as C₁-C₆-alkyl or C₁-C₆-alkoxy.

Examples of preferred biphenols of this formula are hydroquinone, resorcinol, 4,4′-dihydroxydiphenyl, 2,2-bis(4-hydroxyphenyl)propane, 2,4-bis(4-hydroxyphenyl)-2-methylbutane and 1,1-bis(4-hydroxyphenyl)cyclohexane. Particular preference is given to 2,2-bis(4-hydroxyphenyl)propane and 1,1-bis(4-hydroxyphenyl)cyclohexane, and also to 1,1-bis(4-hydroxyphenyl)-3,3,5-trimethylcyclohexane.

Either homopolycarbonates or copolycarbonates are suitable as component A, and preference is given to the copolycarbonates of bisphenol A, as well as to bisphenol A homopolymer.

Suitable polycarbonates may be branched in a known manner, specifically and preferably by incorporating from 0.05 to 2.0 mol %, based on the total of the biphenols used, of at least trifunctional compounds, for example those having three or more phenolic OH groups.

Polycarbonates which have proven particularly suitable have relative viscosities ηᵣₑₗ of from 1.10 to 1.50, in particular from 1.25 to 1.40. This corresponds to average molar masses M_{w} (weight average) of from 10 000 to 200 000 g/mol, preferably from 20 000 to 80 000 g/mol.

The biphenols of the general formula are known per se or can be produced by known processes.

The polycarbonates may, for example, be produced by reacting the biphenols with phosgene in the interfacial process, or with phosgene in the homogeneous-phase process (known as the pyridine process), and in each case the desired molecular weight is achieved in a known manner by using an appropriate amount of known chain terminators. (In relation to polydiorganosiloxane-containing polycarbonates see, for example, DE-A 33 34 782.)

Examples of suitable chain terminators are phenol, p-tert-butylphenol, or else long-chain alkylphenols, such as 4-(1,3-tetramethylbutyl)phenol, as in DE-A 28 42 005, or monoalkylphenols, or dialkylphenols with a total of from 8 to 20 carbon atoms in the alkyl substituents, as in DE-A 35 06 472, such as p-nonylphenol, 3,5-di-tert-butylphenol, p-tert-octylphenol, p-dodecylphenol, 2-(3,5-dimethylheptyl)phenol and 4-(3,5-dimethylheptyl)phenol.

For the purposes of the present invention, halogen-free polycarbonates are polycarbonates made from halogen-free biphenols, from halogen-free chain terminators and optionally from halogen-free branching agents, where the content of subordinate amounts at the ppm level of hydrolyzable chlorine, resulting, for example, from the production of the polycarbonates with phosgene in the interfacial process, is not regarded as meriting the term halogen-containing for the purposes of the invention. Polycarbonates of this type with contents of hydrolyzable chlorine at the ppm level are halogen-free polycarbonates for the purposes of the present invention.

Other suitable components A) which may be mentioned are amorphous polyester carbonates, where phosgene has been replaced, during the preparation, by aromatic dicarboxylic acid units, such as isophthalic acid and/or terephthalic acid units. For further details reference may be made at this point to EP-A 711 810.

Other suitable copolycarbonates with cycloalkyl radicals as monomer units have been described in EP-A 365 916.

It is also possible to replace bisphenol A with bisphenol TMC. Polycarbonates of this type are commercially available from Bayer with the trademark APEC HT®.

The molding compositions of the invention comprise, as preferred component A), from 10 to 98% by weight, preferably from 20 to 97% by weight, and in particular from 30 to 95% by weight, of at least one polyamide.

The intrinsic viscosity of the polyamides of the molding compositions of the invention is generally from 90 to 350 ml/g, preferably from 110 to 240 ml/g, determined in 0.5% strength by weight solution in 96% strength by weight sulfuric acid at 25° C. to ISO 307.

Preference is given to the semicrystalline or amorphous resins with molecular weight (weight-average) of at least 5000 described by way of example in the U.S. Pat. Nos. 2,071,250, 2,071,251, 2,130,523, 2,130,948, 2,241,322, 2,312,966, 2,512,606 and 3,393,210.

Examples of these are polyamides which derive from lactams having from 7 to 13 ring members, examples being polycaprolactam, polycaprylolactam, and polylaurolactam, and also polyamides which are obtained via reaction of dicarboxylic acids with diamines.

Dicarboxylic acids which may be used are alkanedicarboxylic acids having from 6 to 12, in particular from 6 to 10, carbon atoms, and aromatic dicarboxylic acids. A few acids that may be mentioned here are adipic acid, azelaic acid, sebacic acid, dodecanedioic acid and terephthalic and/or isophthalic acid.

Particularly suitable diamines are alkanediamines having from 6 to 12, in particular from 6 to 8, carbon atoms, and also m-xylylenediamine, di(4-aminophenyl)methane, di(4-aminocyclohexyl)methane, 2,2-di(4-aminophenyl)propane, 2,2-di(4-aminocyclohexyl)-propane or 1,5-diamino-2-methylpentane.

Preferred polyamides are polyhexamethyleneadipamide, polyhexamethylenesebacamide and polycaprolactam, and also nylon-6/6,6 copolyamides, in particular having a proportion of from 5 to 95% by weight of caprolactam units.

Other suitable polyamides are obtainable from w-aminoalkyl nitriles, e.g. aminocapronitrile (PA 6) and adipodinitrile with hexamethylenediamine (PA 66) via what is known as direct polymerization in the presence of water, for example as described in DE-A 10313681, EP-A 1198491 and EP 922065.

Mention may also be made of polyamides obtainable, by way of example, via condensation of 1,4-diaminobutane with adipic acid at an elevated temperature (nylon-4,6). Preparation processes for polyamides of this structure are described by way of example in EP-A 38 094, EP-A 38 582, and EP-A 39 524.

Other suitable examples are polyamides obtainable via copolymerization of two or more of the abovementioned monomers, and mixtures of two or more polyamides in any desired mixing ratio. Particular preference is given to mixtures of nylon-6,6 with other polyamides, in particular nylon-6/6,6 copolyamides.

Other polyamides which have proven particularly advantageous are semiaromatic copolyamides, such as PA 6/6T and PA 66/6T, where the triamine content of these is less than 0.5% by weight, preferably less than 0.3% by weight (see EP-A 299 444).

The processes described in EP-A 129 195 and 129 196 can be used to prepare the preferred semiaromatic copolyamides with low triamine content.

The following list, which is not comprehensive, comprises the polyamides A) mentioned and other polyamides A) for the purposes of the invention, and the monomers comprised:

AB polymers:

### PA 4 Pyrrolidone

PA 6 c-Caprolactam

### PA 7 Ethanolactam

### PA 8 Caprylolactam

PA 9 9-Aminopelargonic acid
PA 11 11-Aminoundecanoic acid

### PA 12 Laurolactam

AA/BB polymers:
PA 46 Tetramethylenediamine, adipic acid
PA 66 Hexamethylenediamine, adipic acid
PA 69 Hexamethylenediamine, azelaic acid
PA 610 Hexamethylenediamine, sebacic acid
PA 612 Hexamethylenediamine, decanedicarboxylic acid
PA 613 Hexamethylenediamine, undecanedicarboxylic acid
PA 1212 1,12-Dodecanediamine, decanedicarboxylic acid
PA 1313 1,13-Diaminotridecane, undecanedicarboxylic acid
PA 6T Hexamethylenediamine, terephthalic acid
PA MXD6 m-Xylylenediamine, adipic acid
PA 6I Hexamethylenediamine, isophthalic acid
PA 6-3-T Trimethylhexamethylenediamine, terephthalic acid

### PA 6/6T (see PA 6 and PA 6T)

### PA 6/66 (see PA 6 and PA 66)

### PA 6/12 (see PA 6 and PA 12)

### PA 66/6/610 (see PA 66, PA 6 and PA 610)

### PA 61/6T (see PA 61 and PA 6T)

PA PACM 12 Diaminodicyclohexylmethane, laurolactam
PA 61/6T/PACM as PA 61/6T+diaminodicyclohexylmethane
PA 12/MACMI Laurolactam, dimethyldiaminodicyclohexylmethane, isophthalic acid
PA 12/MACMT Laurolactam, dimethyldiaminodicyclohexylmethane, terephthalic acid
PA PDA-T Phenylenediamine, terephthalic acid

The thermoplastic molding compositions comprise, as component B), from 0.5 to 40% by weight, preferably from 1 to 30% by weight, and in particular from 2 to 20% by weight, of a flame retardant comprising phosphorus.

The phosphorus-containing compounds of component B) are organic and inorganic compounds which comprise phosphorus and in which the valence state of the phosphorus is from −3 to +5. The valence state is the “oxidation state” as set out in Lehrbuch der Anorganischen Chemie [Textbook of inorganic chemistry] from A. F. Hollemann and E. Wiberg, Walter des Gruyter and Co. (1964, 57th to 70th edition), pages 166 to 177. Phosphorus compounds of the valence states from −3 to +5 derive from phosphine (−3), diphosphine (−2), phosphine oxide (−1), elemental phosphorus (+0), hypophosphorous acid (+1), phosphorous acid (+3), hypodiphosphoric acid (+4) and phosphoric acid (+5).

Only a few examples will be mentioned from the large number of phosphorus-containing compounds.

Examples of phosphorus compounds of the phosphine class, which have the valence state −3, include aromatic phosphines, such as triphenylphosphine, tritolylphosphine, trinonylphosphine, trinaphthylphosphine and trisnonylphenylphosphine. Triphenylphosphine is particularly suitable.

Examples of phosphorus compounds of the diphosphine class, having the valence state −2, include tetraphenyldiphosphine and tetranaphthyldiphosphine. Tetranaphthyldiphosphine is particularly suitable.

Phosphorus compounds of the valence state −1 derive from phosphine oxide.

Phosphine oxides of the general formula

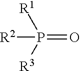

are suitable where R¹, R² and R³ are identical or different alkyl, aryl, alkylaryl or cycloalkyl groups having from 8 to 40 carbon atoms.

Examples of phosphine oxides are triphenylphosphine oxide, tritolylphosphine oxide, trisnonylphenylphosphine oxide, tricyclohexylphosphine oxide, tris(n-butyl)phosphine oxide, tris(n-hexyl)phosphine oxide, tris(n-octyl)phosphine oxide, tris(cyanoethyl)phosphine oxide, benzylbis(cyclohexyl)phosphine oxide, benzylbisphenylphosphine oxide and phenylbis(n-hexyl)phosphine oxide. Other preferred compounds are oxidized reaction products of phosphine with aldehydes, in particular of tert-butylphosphine with glyoxal. Particular preference is given to the use of triphenylphosphine oxide, tricyclohexylphosphine oxide, tris(n-octyl)phosphine oxide or tris(cyanoethyl)phosphine oxide.

Other suitable compounds are triphenylphosphine sulfide and its derivatives as described above for phosphine oxides.

Examples of phosphorus compounds of the “oxidation state”+1 are hypophosphites of purely organic type, e.g. organic hypophosphites such as cellulose hypophosphite esters and esters of hypophosphorous acids with diols, e.g. that of 1,10-dodecyldiol. It is also possible to use substituted phosphinic acids and anhydrides of these, e.g. diphenylphosphinic acid. Other possible compounds are diphenylphosphinic acid, di-p-tolylphosphinic acid and dicresylphosphinic anhydride. Compounds such as the bis(diphenylphosphinic) esters of hydroquinone, ethylene glycol and propylene glycol, inter alia, may also be used. Other suitable compounds are aryl(alkyl)phosphinamides, such as the dimethylamide of diphenylphosphinic acid, and sulfonamidoaryl(alkyl)phosphinic acid derivatives, such as p-tolylsulfonamidodiphenylphosphinic acid. Preference is given to use of the bis(diphenylphosphinic) ester of hydroquinone or of ethylene glycol, or the bis(diphenylphosphinate) of hydroquinone.

Phosphorus compounds of the oxidation state +3 derive from phosphorous acid. Suitable compounds are cyclic phosphonates which derive from pentaerythritol, neopentyl glycol or pyrocatechol, an example being

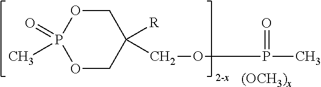

where R is a C₁-C₄-alkyl radical, preferably a methyl radical, x=0 or 1 (Amgard® P 45 from Albright & Wilson).

Phosphorus of the valence state +3 is also present in triaryl(alkyl)phosphites, such as triphenyl phosphite, tris(4-decylphenyl)phosphite, tris(2,4-di-tert-butylphenyl)phosphite and phenyl didecyl phosphite and so on. However, it is also possible to use diphosphites, such as propylene glycol 1,2-bis(diphosphite) or cyclic phosphites which derive from pentaerythritol, from neopentyl glycol or from pyrocatechol.

Particular preference is given to neopentyl glycol methylphosphonate and neopentyl glycol methyl phosphite, and also to pentaerythritol dimethyldiphosphonate and dimethyl pentaerythritol diphosphite.

Phosphorus compounds of oxidation state +4 which may be used are particularly hypodiphosphates, such as tetraphenyl hypodiphosphate and bisneopentyl hypodiphosphate.

Phosphorus compounds of oxidation state +5 which may be used are particularly alkyl- and aryl-substituted phosphates. Examples of these are phenyl bisdodecyl phosphate, phenyl ethyl hydrogenphosphate, phenyl bis(3,5,5-trimethylhexyl) phosphate, ethyl diphenyl phosphate, 2-ethylhexyl ditolyl phosphate, diphenyl hydrogenphosphate, bis(2-ethylhexyl) p-tolyl phosphate, tritolyl phosphate, bis(2-ethylhexyl)phenyl phosphate, di(nonyl)phenyl phosphate, phenyl methyl hydrogenphosphate, didodecyl p-tolyl phosphate, p-tolylbis(2,5,5-trimethylhexyl)phosphate and 2-ethylhexyl diphenyl phosphate. Particularly suitable phosphorus compounds are those in which each radical is aryloxy. Very particularly suitable compounds are triphenyl phosphate and resorcinol bis(diphenyl phosphate) and its ring-substituted derivatives of the general formula (RDP):

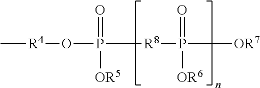

where the definitions of the substituents are as follows:
R⁴-R⁷ are aromatic radicals having from 6 to 20 carbon atoms, preferably phenyl, which may have substitution by alkyl groups having from 1 to 4 carbon atoms, preferably methyl,
R⁸ is a bivalent phenol radical, preferably

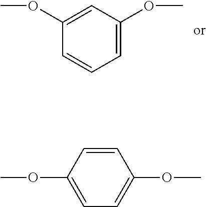

and
n has an average value of from 0.1 to 100, preferably from 0.5 to 50, in particular from 0.8 to 10 and very particularly from 1 to 5.

Due to the process used for their manufacture, RDP products available commercially with trademark Fyroflex® or Fyrol®-RDP (Akzo) and also CR 733-S (Daihachi) are mixtures of about 85% of RDP (n=1) with about 2.5% of triphenyl phosphate and also about 12.5% of oligomeric fractions in which the degree of oligomerization is mostly less than 10.

It is also possible to use cyclic phosphates. Of these, diphenyl pentaerythritol diphosphate and phenyl neopentyl phosphate are particularly suitable.

Besides the low-molecular-weight phosphorus compounds mentioned above, it is also possible to use oligomeric or polymeric phosphorus compounds.

Polymeric, halogen-free organic phosphorus compounds of this type with phosphorus in the polymer chain are produced, for example, in the preparation of pentacyclic unsaturated phosphine dihalides, as described, for example, in DE-A 20 36 173. The molecular weight of the polyphospholine oxides, measured by vapor pressure osmometry in dimethylformamide, should be in the range from 500 to 7000, preferably from 700 to 2000.

Phosphorus here has the oxidation state −1.

It is also possible to use inorganic coordination polymers of aryl(alkyl)phosphinic acids, such as poly-β-sodium(I) methylphenylphosphinate. Their preparation is given in DE-A 31 40 520. Phosphorus has the oxidation number +1.

Halogen-free polymeric phosphorus compounds of this type may also be produced by the reaction of a phosphonic acid chloride, such as phenyl-, methyl-, propyl-, styryl- or vinylphosphonyl dichloride, with dihydric phenols, such as hydroquinone, resorcinol, 2,3,5-trimethylhydroquinone, bisphenol A, or tetramethylbisphenol A.

Other halogen-free polymeric phosphorus compounds which may be present in the inventive molding compositions are prepared by reacting phosphorus oxytrichloride or phosphoric ester dichlorides with a mixture of mono-, di- and trihydric phenols and other compounds carrying hydroxy groups (cf. Houben-Weyl-Müller, Thieme-Verlag, Stuttgart, Germany, Organische Phosphorverbindungen Part II (1963)). It is also possible to produce polymeric phosphonates via transesterification reactions of phosphonic esters with dihydric phenols (cf. DE-A 29 25 208) or via reactions of phosphonic esters with diamines, or with diamides or hydrazides (cf. U.S. Pat. No. 4,403,075). The inorganic compound poly(ammonium phosphate) may also be used.

It is also possible to use oligomeric pentaerythritol phosphites, pentaerythritol phosphates and pentaerythritol phosphonates, in accordance with EP-B 8 486, for example Mobil Antiblaze® 19 (registered trade mark of Mobil Oil).

Preferred components B) are phosphinic salts of the formula

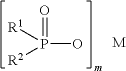

and/or diphosphinic salts of the formula

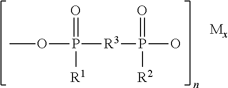

where the definitions of the substituents are as follows:
R¹ and R² are identical or different, being hydrogen, C₁-C₆-alkyl, linear or branched, and/or aryl;
R³ is C₁-C₁₀-alkylene, linear or branched, or C₆-C₁₀-arylene, -alkylarylene, or -arylalkylene;
M is Mg, Ca, Al, Sb, Sn, Ge, Ti, Zn, Fe, Zr, Ce, Bi, Sr, Mn, Li, Na, K, and/or a protonated nitrogen base;
m is from 1 to 4; n is from 1 to 4; x is from 1 to 4.

It is preferable that R¹ and R² of component B, being identical or different, are methyl, ethyl, n-propyl, isopropyl, n-butyl, tert-butyl, n-pentyl, and/or phenyl.

It is preferable that R³ of component B is methylene, ethylene, n-propylene, isopropylene, n-butylene, tert-butylene, n-pentylene, n-octylene, or n-dodecylene, phenylene, or naphthylene; methylphenylene, ethylphenylene, tert-butylphenylene, methylnaphthylene, ethylnaphthylene, or tert-butylnaphthylene; phenylmethylene, phenylethylene, phenylpropylene, or phenylbutylene.

It is particularly preferable that R¹ and R² are methyl, ethyl, and that M=Al.

Preference is further given to melamine polyphosphate salts of a 1,3,5-triazine compound, where the index n of the average degree of condensation thereof is from 20 to 200, and the 1,3,5-triazine content is from 1.1 to 2.0 mol of a 1,3,5-triazine compound selected from the group consisting of melamine, melam, melem, melon, ammeline, ammelide, 2-ureidomelamine, acetoguanamine, benzoguanamine, and diaminophenyltriazine, per mole of phosphorus atom. The n value of these salts is preferably generally from 40 to 150, and the ratio of a 1,3,5-triazine compound per mole of phosphorus atom is preferably from 1.2 to 1.8. The pH of a 10% strength by weight aqueous slurry of salts produced according to EP1095030B1 is moreover generally more than 4.5 and preferably at least 5.0. The usual method of determining the pH consists in adding 25 g of the salt and 225 g of pure water at 25° C. to a 300 ml beaker, stirring the resultant aqueous slurry for 30 minutes, and then measuring the pH. The abovementioned n value, the numeric average degree of condensation, can be determined by means of 31P solid-state NMR. J. R. van Wazer, C. F. Callis, J. Shoolery and R. Jones, J. Am. Chem. Soc., 78, 5715, 1956 have disclosed that the number of adjacent phosphate groups gives a unique chemical shift which permits clear differentiation between orthophosphates, pyrophosphates, and polyphosphates. EP1095030B1 moreover describes a method for producing the desired polyphosphate salt of a 1,3,5-triazine compound which has an n value of from 20 to 200, where the 1,3,5-triazine content thereof is from 1.1 to 2.0 mol of a 1,3,5-triazine compound. This method comprises conversion of a 1,3,5-triazine compound to its orthophosphate salt, using orthophosphoric acid, followed by dehydration and heat treatment, in order to convert the orthophosphate salt to a polyphosphate of the 1,3,5-triazine compound. This heat treatment is preferably carried out at a temperature of at least 300° C., and preferably at least 310° C. As well as orthophosphates of 1,3,5-triazine compounds, it is equally possible to use other 1,3,5-triazine phosphates, inclusive by way of example of a mixture of orthophosphates and pyrophosphates.

Preference is further given to phosphorus compounds of the general formula:

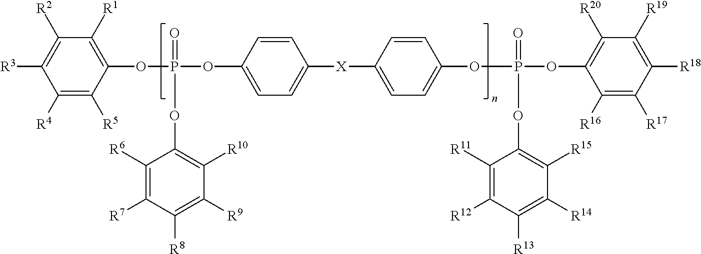

where the definitions of the substituents are as follows:
R¹ to R²⁰, independently of one another, are hydrogen, or a linear or branched alkyl group having up to 6 carbon atoms
n has an average value of from 0.5 to 50, and
X is a single bond, C═O, S, SO₂, C(CH₃)₂.

Preferred compounds B) are those in which R¹ to R²⁰, independently of one another, are hydrogen and/or a methyl radical. If R¹ to R²⁰, independently of one another, are a methyl radical, preference is given to those compounds in which the radicals R¹, R⁵, R⁶, R¹⁰, R¹¹, R¹⁵, R¹⁶, R²⁰ in ortho-position with respect to the oxygen of the phosphate group are at least one methyl radical. Preference is also given to compounds B) in which one methyl group is present per aromatic ring, preferably in ortho-position, and the other radicals are hydrogen.

Particularly preferred substituents are SO₂ and S, and C(CH₃)₂ is very particularly preferred for X in the above formula.

The average value of n is preferably from 0.5 to 5, in particular from 0.7 to 2, and in particular ≈11.

The statement of n as an average value is a consequence of the preparation process for the compounds listed above, the degree of oligomerization mostly being smaller than 10 and the content of triphenyl phosphate present being very small (mostly <5% by weight), there being a difference here from batch to batch. The compounds B) are commercially available as CR-741 from Daihachi.

Particularly preferred component B) is elemental phosphorus (valence state 0). Red and black phosphorus are used, preference being given here to red phosphorus.

Preferred flame retardant (B) is elemental red phosphorus, which can be used in untreated form.

However, particularly suitable materials are preparations in which the phosphorus has been surface-coated with low-molecular-weight liquid substances, such as silicone oil, paraffin oil, or esters of phthalic acid or adipic acid, or with polymeric or oligomeric compounds, e.g. with phenolic resins or amino plastics.

A process known as surface phlegmatization, based on polyester polyurethanes or on polyurethanes, is found by way of example in DE-A 39 05 038.

Other suitable phlegmatizing agents are mineral oils, paraffin oils, chloroparaffins, esters of trimellitic acid, preferably of alcohols having from 5 to 10 carbon atoms, e.g. trioctyl trimellitate, and aromatic phosphate compounds, an example being tricresyl phosphate.

Materials used with particular preference as phlegmatizing agents are esters of phthalic acid obtainable from phthalic acid and from alcohols having from 6 to 13 carbon atoms. Dioctyl phthalates are particularly preferred, and particular preference is given here to di-2-ethylhexyl phthalate.

Particular preference is given to coatings which are a combination of from 0.01 to 2% by weight, preferably from 0.1 to 1.5% by weight, and in particular from 0.4 to 1.0% by weight, of a phlegmatizing agent and from 2 to 15% by weight, preferably from 3 to 10% by weight, and in particular from 4 to 8% by weight, of a mineral filler.

The percentage by weight data for the mineral filler and for the phlegmatizing agent, and also for the red phosphorus, respectively give 100% by weight.

The average particle size (d₅₀) of the phosphorus particles dispersed in the molding compositions is usually in the range up to 2 mm, preferably from 0.0001 to 0.5 mm.

Preferred suitable mineral fillers are calcium silicates or magnesium silicates, preference being given here to wollastonite and talc.

The average particle size (d₅₀) is usually from 1 to 500 μm.

Compositions of this type and production processes for component B) are found in DE-A 1 96 48 503.

Concentrates of phlegmatized phosphorus, e.g. in a polyamide or polyolefin, or in an elastomer, are also suitable, and the phosphorus contents of these can be up to 60% by weight.

The molding compositions of the invention comprise, as component C), from 0.5 to 35% by weight, preferably from 1 to 20% by weight, and in particular from 1 to 10% by weight, of an iron sulfide.

Preferred iron sulfide is FeS₂, which is the Fe(II) salt of the S₂²⁻ ion.

This is produced naturally from FeS and sulfur compounds in organic material or sulfate with the aid of microorganisms.

The mineral FeS₂ occurs in two forms, namely pyrite and marcasite, both of which are also termed pyrites.

FeS₂ can be synthesized via reaction of FeCl₃ with H₂S at red heat or via heating of Fe(II) sulfide with elemental sulfur.

FeS₂ is available commercially in the form of a black powder, the S content of which (elemental sulfur) is preferably greater than 35%, in particular 45%.

Sulfur content is determined here as follows:

The specimen is weighed into a tin capsule and ignited in a stream of helium at about 1000° C. with addition of oxygen. The resultant combustion gases are converted to defined species with the aid of appropriate catalysts, and these are detected by TCD.
Sulfur: Quantification in the form of SO₂ by means of thermal conductivity detection (TCD).
Range of input weights: from 1 to 5 mg, accurate to 0.001 mg
Detection limit: w(C) 0.01 g/100 g
Measurement accuracy: ±0.001 g/100 g
Example of equipment: Euro EA elemental analyzer from Eurovector
Literature: F. Ehrenberger “Quantitative organische Elementaranalyse”[Quantitative organic elemental analysis]

The preferred particle size is d₉₀<1000 μm, in particular d₉₀<100 μm, and the d₅₀ is preferably <50 μm (determined to ISO 13320-1).

The molding compositions of the invention can comprise up to 70% by weight, preferably up to 50% by weight, of further additives as component D).

Fibrous or particulate fillers D) that may be mentioned are carbon fibers, glass fibers, glass beads, amorphous silica, calcium silicate, calcium metasilicate, magnesium carbonate, kaolin, chalk, powdered quartz, mica, barium sulfate, and feldspar, the amounts used of these being from 1 to 30% by weight, in particular from 5 to 30% by weight, preferably from 10 to 30% by weight.

Preferred fibrous fillers which may be mentioned are carbon fibers, aramid fibers and potassium titanate fibers, and particular preference is given to glass fibers in the form of E glass. These may be used as rovings or in the commercially available forms of chopped glass.

The fibrous fillers may have been surface-pretreated with a silane compound to improve compatibility with the thermoplastic.

Suitable silane compounds have the general formula:

(X—(OH₂)ₙ)ₖ—Si—(O—CₘH₂ₘ₊₁)₄₋ₖ

where the definitions of the substituents are as follows:

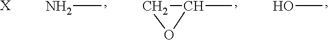

n is a whole number from 2 to 10, preferably 3 to 4,
m is a whole number from 1 to 5, preferably 1 to 2, and
k is a whole number from 1 to 3, preferably 1.

Preferred silane compounds are aminopropyltrimethoxysilane, aminobutyltrimethoxysilane, aminopropyltriethoxysilane and aminobutyltriethoxysilane, and also the corresponding silanes which comprise a glycidyl group as substituent X.

The amounts of the silane compounds generally used for surface-coating are from 0.01 to 2% by weight, preferably from 0.025 to 1.0% by weight and in particular from 0.05 to 0.5% by weight (based on E)).

Acicular mineral fillers are also suitable.

For the purposes of the invention, acicular mineral fillers are mineral fillers with strongly developed acicular character. An example is acicular wollastonite. The mineral preferably has an L/D (length to diameter) ratio of from 8:1 to 35:1, preferably from 8:1 to 11:1. The mineral filler may optionally have been pretreated with the abovementioned silane compounds, but the pretreatment is not essential.

Other fillers which may be mentioned are kaolin, calcined kaolin, wollastonite, talc and chalk, and also lamellar or acicular nanofillers, the amounts of these preferably being from 0.1 to 10%. Materials preferred for this purpose are boehmite, bentonite, montmorillonite, vermiculite, hectorite, and laponite. The lamellar nanofillers are organically modified by prior-art methods, to give them good compatibility with the organic binder. Addition of the lamellar or acicular nanofillers to the inventive nanocomposites gives a further increase in mechanical strength.

The molding compositions of the invention can comprise, as further component D), from 0.05 to 3% by weight, preferably from 0.1 to 1.5% by weight, and in particular from 0.1 to 1% by weight, of a lubricant.

Preference is given to the salts of Al, of alkali metals, or of alkaline earth metals, or esters or amides of fatty acids having from 10 to 44 carbon atoms, preferably having from 12 to 44 carbon atoms.

The metal ions are preferably alkaline earth metal and Al, particular preference being given to Ca or Mg.

Preferred metal salts are Ca stearate and Ca montanate, and also Al stearate.

It is also possible to use a mixture of various salts, in any desired mixing ratio.

The carboxylic acids can be monobasic or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols can be monohydric to tetrahydric. Examples of alcohols are n-butanol, n-octanol, stearyl alcohol, ethylene glycol, propylene glycol, neopentyl glycol, and pentaerythritol, preference being given to glycerol and pentaerythritol.

The aliphatic amines can be mono- to tribasic. Examples of these are stearylamine, ethylenediamine, propylenediamine, hexamethylenediamine, di(6-aminohexyl)amine, particular preference being given to ethylenediamine and hexamethylenediamine. Preferred esters or amides are correspondingly glycerol distearate, glycerol tristearate, ethylenediamine distearate, glycerol monopalmitate, glycerol trilaurate, glycerol monobehenate, and pentaerythritol tetrastearate.

It is also possible to use a mixture of various esters or amides, or of esters with amides in combination, in any desired mixing ratio.

The molding compositions of the invention can comprise, as further component D), from 0.05 to 3% by weight, preferably from 0.1 to 1.5% by weight, and in particular from 0.1 to 1% by weight, of a copper stabilizer, preferably of a Cu(I) halide, in particular in a mixture with an alkali metal halide, preferably KI, in particular in the ratio 1:4, or of a sterically hindered phenol, or a mixture of these.

Preferred salts of monovalent copper used are cuprous acetate, cuprous chloride, cuprous bromide, and cuprous iodide. The materials comprise these in amounts of from 5 to 500 ppm of copper, preferably from 10 to 250 ppm, based on polyamide.

The advantageous properties are in particular obtained if the copper is present with molecular distribution in the polyamide. This is achieved if a concentrate comprising polyamide, and comprising a salt of monovalent copper, and comprising an alkali metal halide in the form of a solid, homogeneous solution is added to the molding composition. By way of example, a typical concentrate is composed of from 79 to 95% by weight of polyamide and from 21 to 5% by weight of a mixture composed of copper iodide or copper bromide and potassium iodide. The copper concentration in the solid homogeneous solution is preferably from 0.3 to 3% by weight, in particular from 0.5 to 2% by weight, based on the total weight of the solution, and the molar ratio of cuprous iodide to potassium iodide is from 1 to 11.5, preferably from 1 to 5.

Suitable polyamides for the concentrate are homopolyamides and copolyamides, in particular nylon-6 and nylon-6,6.

Suitable sterically hindered phenols D) are in principle any of the compounds having a phenolic structure and having at least one bulky group on the phenolic ring.

By way of example, compounds of the formula

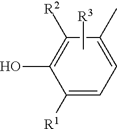

can preferably be used, in which:

R¹ and R² are an alkyl group, a substituted alkyl group, or a substituted triazole group, where the radicals R¹ and R² can be identical or different, and R³ is an alkyl group, a substituted alkyl group, an alkoxy group, or a substituted amino group.

Antioxidants of the type mentioned are described by way of example in DE-A 27 02 661 (U.S. Pat. No. 4,360,617).

Another group of preferred sterically hindered phenols is those derived from substituted benzenecarboxylic acids, in particular from substituted benzenepropionic acids.

Particularly preferred compounds from this class are compounds of the formula

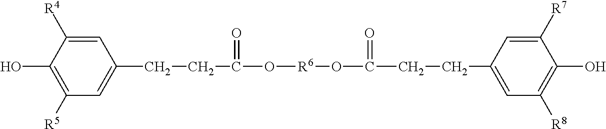

where R⁴, R⁵, R⁷, and R⁸, independently of one another, are C₁-C₈-alkyl groups which themselves may have substitution (at least one of these being a bulky group), and R⁶ is a divalent aliphatic radical which has from 1 to 10 carbon atoms and whose main chain may also have C—O bonds.

Preferred compounds corresponding to this formula are

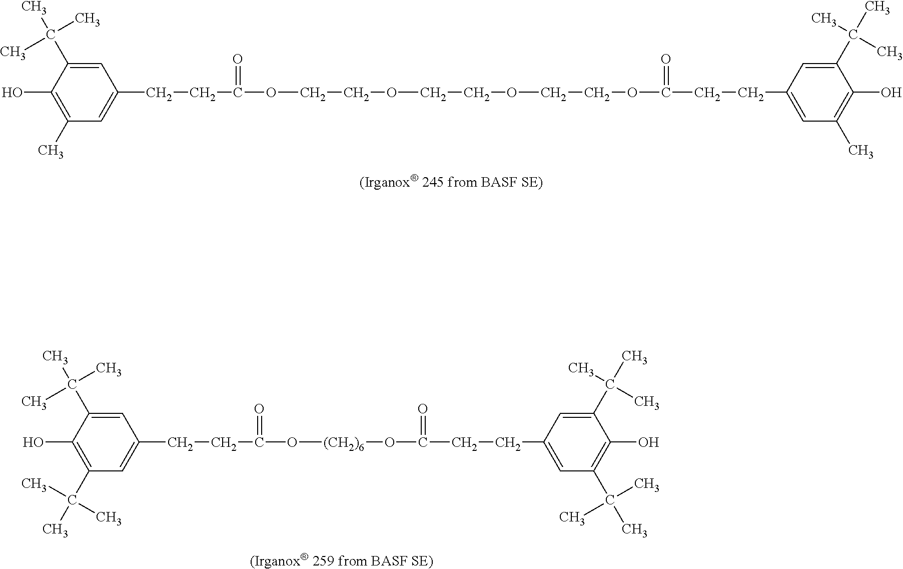

All of the following should be mentioned as examples of sterically hindered phenols:

2,2′-methylenebis(4-methyl-6-tert-butylphenol), 1,6-hexanediol bis[3-(3,5-di-tert-butyl-4-hydroxyphenyl)propionate], pentaerythrityl tetrakis[3-(3,5-di-tert-butyl-4-hydroxyphenyl)-propionate], distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxybenzyl)benzene, 4,4′-methylenebis(2,6-di-tert-butylphenol), 3,5-di-tert-butyl-4-hydroxybenzyldimethylamine.

Compounds which have proven particularly effective and which are therefore used with preference are 2,2′-methylenebis(4-methyl-6-tert-butylphenol), 1,6-hexanediol bis(3,5-di-tert-butyl-4-hydroxyphenyl)propionate (Irganox® 259), pentaerythrityl tetrakis[3-(3,5-di-tert-butyl-4-hydroxyphenyl)propionate], and also N,N′-hexamethylenebis-3,5-di-tert-butyl-4-hydroxyhydrocinnamide (Irganox® 1098), and the product Irganox® 245 described above from Ciba Geigy, which has particularly good suitability.

The amount comprised of the antioxidants D), which can be used individually or as a mixture, is from 0.05 up to 3% by weight, preferably from 0.1 to 1.5% by weight, in particular from 0.1 to 1% by weight, based on the total weight of the molding compositions A) to D).

In some instances, sterically hindered phenols having not more than one sterically hindered group in ortho-position with respect to the phenolic hydroxy group have proven particularly advantageous, in particular when assessing colorfastness on storage in diffuse light over prolonged periods.

The molding compositions of the invention can comprise, as further component D), from 0.05 to 5% by weight, preferably from 0.1 to 2% by weight, and in particular from 0.25 to 1% by weight, of a nigrosin.

Nigrosins are generally a group of black or gray phenazine dyes (azine dyes) related to the indulines and taking various forms (water-soluble, oleosoluble, spirit-soluble), used in wool dyeing and wool printing, in black dyeing of silks, and in the coloring of leather, of shoe creams, of varnishes, of plastics, of stoving lacquers, of inks, and the like, and also as microscopy dyes.

Nigrosins are obtained industrially via heating of nitrobenzene, aniline, and aniline hydrochloride with metallic iron and FeCl₃ (the name being derived from the Latin niger=black).

Component D) can be used in the form of free base or else in the form of salt (e.g. hydrochloride).

Further details concerning nigrosins can be found by way of example in the electronic encyclopedia Römpp Online, Version 2.8, Thieme-Verlag Stuttgart, 2006, keyword “Nigrosin”.

Examples of other conventional additives D) are amounts of up to 25% by weight, preferably up to 20% by weight, of elastomeric polymers (also often termed impact modifiers, elastomers, or rubbers).

These are very generally copolymers preferably composed of at least two of the following monomers: ethylene, propylene, butadiene, isobutene, isoprene, chloroprene, vinyl acetate, styrene, acrylonitrile and acrylates and/or methacrylates having from 1 to 18 carbon atoms in the alcohol component.

Polymers of this type are described, for example, in Houben-Weyl, Methoden der organischen Chemie, Vol. 14/1 (Georg-Thieme-Verlag, Stuttgart, Germany, 1961), pages 392-406, and in the monograph by C. B. Bucknall, “Toughened Plastics” (Applied Science Publishers, London, UK, 1977).

Some preferred types of such elastomers are described below.

Preferred types of such elastomers are those known as ethylene-propylene (EPM) and ethylene-propylene-diene (EPDM) rubbers.

EPM rubbers generally have practically no residual double bonds, whereas EPDM rubbers may have from 1 to 20 double bonds per 100 carbon atoms.

Examples which may be mentioned of diene monomers for EPDM rubbers are conjugated dienes, such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadienes, cyclooctadienes and dicyclopentadiene, and also alkenylnorbornenes, such as 5-ethylidene-2-norbornene, 5-butylidene-2-norbornene, 2-methallyl-5-norbornene and 2-isopropenyl-5-norbornene, and tricyclodienes, such as 3-methyltricyclo[5.2.1.0²⁶]-3,8-decadiene, and mixtures of these. Preference is given to 1,5-hexadiene, 5-ethylidenenorbornene and dicyclopentadiene. The diene content of the EPDM rubbers is preferably from 0.5 to 50% by weight, in particular from 1 to 8% by weight, based on the total weight of the rubber.

EPM and EPDM rubbers may preferably also have been grafted with reactive carboxylic acids or with derivatives of these. Examples of these are acrylic acid, methacrylic acid and derivatives thereof, e.g. glycidyl (meth)acrylate, and also maleic anhydride.

Copolymers of ethylene with acrylic acid and/or methacrylic acid and/or with the esters of these acids are another group of preferred rubbers. The rubbers may also comprise dicarboxylic acids, such as maleic acid and fumaric acid, or derivatives of these acids, e.g. esters and anhydrides, and/or monomers comprising epoxy groups. These monomers comprising dicarboxylic acid derivatives or comprising epoxy groups are preferably incorporated into the rubber by adding to the monomer mixture monomers comprising dicarboxylic acid groups and/or epoxy groups and having the general formulae I, II, III or IV

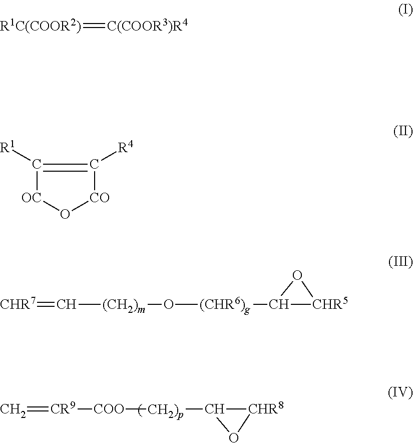

where R¹ to R⁹ are hydrogen or alkyl groups having from 1 to 6 carbon atoms, and m is a whole number from 0 to 20, g is a whole number from 0 to 10 and p is a whole number from 0 to 5.

The radicals R¹ to R⁹ are preferably hydrogen, where m is 0 or 1 and g is 1. The corresponding compounds are maleic acid, fumaric acid, maleic anhydride, allyl glycidyl ether and vinyl glycidyl ether.

Preferred compounds of the formulae I, II and IV are maleic acid, maleic anhydride and (meth)acrylates comprising epoxy groups, such as glycidyl acrylate and glycidyl methacrylate, and the esters with tertiary alcohols, such as tert-butyl acrylate. Although the latter have no free carboxy groups, their behavior approximates to that of the free acids and they are therefore termed monomers with latent carboxy groups.

The copolymers are advantageously composed of from 50 to 98% by weight of ethylene, from 0.1 to 20% by weight of monomers comprising epoxy groups and/or methacrylic acid and/or monomers comprising anhydride groups, the remaining amount being (meth)acrylates.

Particular preference is given to copolymers composed of
from 50 to 98% by weight, in particular from 55 to 95% by weight, of ethylene,
from 0.1 to 40% by weight, in particular from 0.3 to 20% by weight, of glycidyl acrylate and/or glycidyl methacrylate, (meth)acrylic acid and/or maleic anhydride, and
from 1 to 45% by weight, in particular from 5 to 40% by weight, of n-butyl acrylate and/or 2-ethylhexyl acrylate.

Other preferred (meth)acrylates are the methyl, ethyl, propyl, isobutyl and tert-butyl esters.

Comonomers which may be used alongside these are vinyl esters and vinyl ethers.

The ethylene copolymers described above may be prepared by processes known per se, preferably by random copolymerization at high pressure and elevated temperature. Appropriate processes are well-known.

Other preferred elastomers are emulsion polymers whose preparation is described, for example, by Blackley in the monograph “Emulsion Polymerization”. The emulsifiers and catalysts which can be used are known per se.

In principle it is possible to use homogeneously structured elastomers or else those with a shell structure. The shell-type structure is determined by the sequence of addition of the individual monomers. The morphology of the polymers is also affected by this sequence of addition.

Monomers which may be mentioned here, merely as examples, for the preparation of the rubber fraction of the elastomers are acrylates, such as n-butyl acrylate and 2-ethylhexyl acrylate, corresponding methacrylates, butadiene and isoprene, and also mixtures of these. These monomers may be copolymerized with other monomers, such as styrene, acrylonitrile, vinyl ethers and with other acrylates or methacrylates, such as methyl methacrylate, methyl acrylate, ethyl acrylate or propyl acrylate.

The soft or rubber phase (with a glass transition temperature of below 0° C.) of the elastomers may be the core, the outer envelope or an intermediate shell (in the case of elastomers whose structure has more than two shells). Elastomers having more than one shell may also have more than one shell composed of a rubber phase.

If one or more hard components (with glass transition temperatures above 20° C.) are involved, besides the rubber phase, in the structure of the elastomer, these are generally prepared by polymerizing, as principal monomers, styrene, acrylonitrile, methacrylonitrile, α-methylstyrene, p-methylstyrene, or acrylates or methacrylates, such as methyl acrylate, ethyl acrylate or methyl methacrylate. Besides these, it is also possible here to use relatively small proportions of other comonomers.

It has proven advantageous in some cases to use emulsion polymers which have reactive groups at their surfaces. Examples of groups of this type are epoxy, carboxy, latent carboxy, amino and amide groups, and also functional groups which may be introduced by concomitant use of monomers of the general formula

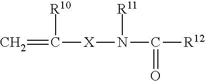

where the substituents can be defined as follows:
R¹⁰ is hydrogen or a C₁-C₄-alkyl group,
R¹¹ is hydrogen, a C₁-C₈-alkyl group or an aryl group, in particular phenyl,
R¹² is hydrogen, a C₁-C₁₀-alkyl group, a C₆-C₁₂-aryl group, or —OR¹³,
R¹³ is a C₁-C₈-alkyl group or a C₆-C₁₂-aryl group, which can optionally have substitution by groups that comprise 0 or by groups that comprise N,
X is a chemical bond, a C₁-C₁₀-alkylene group, or a C₆-C₁₂-arylene group, or

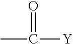

Y is O—Z or NH—Z, and
Z is a C₁-C₁₀-alkylene or C₆-C₁₂-arylene group.

The graft monomers described in EP-A 208 187 are also suitable for introducing reactive groups at the surface.

Other examples which may be mentioned are acrylamide, methacrylamide and substituted acrylates or methacrylates, such as (N-tert-butylamino)ethyl methacrylate, (N,N-dimethylamino)ethyl acrylate, (N,N-dimethylamino)methyl acrylate and (N,N-diethylamino)ethyl acrylate.

The particles of the rubber phase may also have been crosslinked. Examples of crosslinking monomers are 1,3-butadiene, divinylbenzene, diallyl phthalate and dihydrodicyclopentadienyl acrylate, and also the compounds described in EP-A 50 265.

It is also possible to use the monomers known as graft-linking monomers, i.e. monomers having two or more polymerizable double bonds which react at different rates during the polymerization. Preference is given to the use of compounds of this type in which at least one reactive group polymerizes at about the same rate as the other monomers, while the other reactive group (or reactive groups), for example, polymerize(s) significantly more slowly. The different polymerization rates give rise to a certain proportion of unsaturated double bonds in the rubber. If another phase is then grafted onto a rubber of this type, at least some of the double bonds present in the rubber react with the graft monomers to form chemical bonds, i.e. the phase grafted on has at least some degree of chemical bonding to the graft base.

Examples of graft-linking monomers of this type are monomers comprising allyl groups, in particular allyl esters of ethylenically unsaturated carboxylic acids, for example allyl acrylate, allyl methacrylate, diallyl maleate, diallyl fumarate and diallyl itaconate, and the corresponding monoallyl compounds of these dicarboxylic acids. Besides these there is a wide variety of other suitable graft-linking monomers. For further details reference may be made here, for example, to U.S. Pat. No. 4,148,846.

The proportion of these crosslinking monomers in the impact-modifying polymer is generally up to 5% by weight, preferably not more than 3% by weight, based on the impact-modifying polymer.

Some preferred emulsion polymers are listed below. Mention may first be made here of graft polymers with a core and with at least one outer shell, and having the following structure:

| Type | Monomers for the core | Monomers for the envelope |
|---|---|---|
| I | 1,3-butadiene, isoprene, n-butyl | styrene, acrylonitrile, methyl |
| | acrylate, ethylhexyl acrylate, | methacrylate |
| | or a mixture of these | |
| II | as I, but with concomitant use of | as I |
| | crosslinking agents | |
| III | as I or II | n-butyl acrylate, ethyl acrylate, |
| | | methyl acrylate, 1,3-butadiene, |
| | | isoprene, ethylhexyl acrylate |
| IV | as I or II | as I or III, but with concomitant |
| | | use of monomers having |
| | | reactive groups, as described |
| | | herein |
| V | styrene, acrylonitrile, methyl | first envelope composed of |
| | methacrylate, or a mixture | monomers as described under I |
| | of these | and II for the core, second |
| | | envelope as described under |
| | | I or IV for the envelope |

Instead of graft polymers whose structure has more than one shell, it is also possible to use homogeneous, i.e. single-shell, elastomers composed of 1,3-butadiene, isoprene and n-butyl acrylate or of copolymers of these. These products, too, may be prepared by concomitant use of crosslinking monomers or of monomers having reactive groups.

Examples of preferred emulsion polymers are n-butyl acrylate-(meth)acrylic acid copolymers, n-butyl acrylate-glycidyl acrylate or n-butyl acrylate-glycidyl methacrylate copolymers, graft polymers with an inner core composed of n-butyl acrylate or based on butadiene and with an outer envelope composed of the abovementioned copolymers, and copolymers of ethylene with comonomers which supply reactive groups.

The elastomers described may also be prepared by other conventional processes, e.g. by suspension polymerization.

Preference is also given to silicone rubbers, as described in DE-A 37 25 576, EP-A 235 690, DE-A 38 00 603 and EP-A 319 290.

It is, of course, also possible to use mixtures of the types of rubber listed above.

The thermoplastic molding compositions of the invention can comprise, as component D), conventional processing aids, such as stabilizers, oxidation retarders, agents to counteract decomposition by heat and decomposition by ultraviolet light, lubricants and mold-release agents, colorants, such as dyes and pigments, nucleating agents, plasticizers, etc. Examples of oxidation retarders and heat stabilizers are sterically hindered phenols and/or phosphites and amines (e.g. TAD), hydroquinones, aromatic secondary amines, such as diphenylamines, various substituted members of these groups, and mixtures of these, in concentrations of up to 1% by weight, based on the weight of the thermoplastic molding compositions.

UV stabilizers that may be mentioned, the amounts of which used are generally up to 2% by weight, based on the molding composition, are various substituted resorcinols, salicylates, benzotriazoles, and benzophenones.

Materials that can be added as colorants are inorganic pigments, such as titanium dioxide, ultramarine blue, iron oxide, and carbon black, and also organic pigments, such as phthalocyanines, quinacridones, perylenes, and also dyes, such as anthraquinones.

Materials that can be used as nucleating agents are sodium phenylphosphinate, aluminum oxide, silicon dioxide, and also preferably talc.

Examples of flame retardant synergists that can be used are PTFE, zinc salts (zinc borate, Zn oxide), silica salts (silicon dioxides).

The thermoplastic molding compositions of the invention can be produced by processes known per se, by mixing the starting components in conventional mixing apparatus, such as screw-based extruders, Brabender mixers, or Banbury mixers, and then extruding the same. The extrudate can be cooled and pelletized. It is also possible to premix individual components and then to add the remaining starting materials individually and/or likewise in the form of a mixture. The mixing temperatures are generally from 230 to 320′C.

In another preferred procedure, it is possible to mix components B) to C) and also optionally D) with a prepolymer, and subject the material to compounding and pelletization. The pellets obtained are then subjected to solid-phase condensation under an inert gas, continuously or batchwise, at a temperature below the melting point of component A) until the desired viscosity has been reached.

Production by means of what is known as the pultrusion process is likewise preferred.

The thermoplastic molding compositions of the invention feature good flame retardancy and good mechanical properties. The amounts needed of the flame retardant in order to achieve fire classification V-0 are moreover relatively small. Improved LOI value, and also improved P stability, are moreover obtained.

The materials are suitable for the production of fibers, of foils, and of moldings, of any type. Some examples are: cylinder-head covers, motorcycle covers, intake pipes, charge-air-cooler caps, plug connectors, gearwheels, cooling-fan wheels, cooling-water tanks.

In the electrical and electronic sector, polyamides of this type can be used to produce plugs, plug parts, plug connectors, cable-harness components, circuit substrates, circuit-substrate components, three-dimensionally injection-molded circuit substrates, electrical connectors and mechatronic components.

In automobile interiors, possible uses are for dashboards, steering-column switches, seat components, headrests, center consoles, transmission-system components, and door modules, and in automobile exteriors possible uses are for door handles, exterior-mirror components, windshield-wiper components, windshield-wiper protective housings, decorative grilles, roof rails, sunroof frames, engine covers, cylinder-head covers, intake pipes (in particular intake manifolds), windshield wipers, and also external bodywork components.

Possible uses of improved-flow polyamides for the kitchen and household sector are the production of components for kitchen machines, e.g. fryers, smoothing irons, and knobs, and there are also possible applications in the garden and leisure sector, e.g. components for irrigation systems, or garden equipment and door handles.

### EXAMPLES

The following components were used:

### Component A

Nylon-6,6 with IV of 150 ml/g to ISO 307

(Ultramid® A24 from BASF SE was used).

### Component B/1

Red phosphorus (phlegmatized with dioctyl phthalate)

(in the form of 50% strength masterbatch in PA 6)

### Component B/2

Red phosphorus in the form of 40% strength masterbatch in PA 6

### Component B/3

Aluminum diethylphosphinate (Exolit® OP1230 from Clariant)

### Component B/4

Melamine polyphosphate (Melapur®200 from BASF SE)

### Component C

FeS₂ d₉₀<60 μm, d₅₀<25 μm
S content: 50%, determined by the method on pages 16-17 of the description

### Component D1

Glass fibers

### Component D2

Antioxidants: Irganox® 1098 from BASF SE and ZnO (1:2)

### Component D3

Lubricants: Ca stearate, Zn stearate, stearyl stearate (5:0.5:1)

### Component D4

Copolymer of ethylene/n-butyl acrylate/acrylic acid/maleic anhydride

The molding compositions were produced in a ZSK 25 with throughput of 10 kg/h with a flat temperature profile at about 290° C.

The measurements carried out were as follows:

Determination of UL 94 flame-retardancy classification on specimens of thickness 0.8 mm.

LOI (limiting oxygen index) values were determined to ISO 4589-2.

The table gives the constitution of the molding compositions and the results of the measurements.

| Components | Example | | | | | | | |
|---|---|---|---|---|---|---|---|---|
| [% by wt.] | 1 comp | 2 | 3 comp | 4 | 5 comp | 6 comp | 7 comp | 8 |
| A) | 61.5 | 61.5 | 58.5 | 58.5 | 48.5 | 50.25 | 53.5 | 50.25 |
| B1 | 10 | 5 | — | — | — | — | — | — |
| B2 | — | — | — | — | — | 16.25 | 13 | 13 |
| B3 | — | — | 10 | 10 | — | — | — | — |
| B4 | — | — | 5 | 2 | — | — | — | — |
| C | — | 5 | — | 3 | 30 | — | — | 3.25 |
| D1 | 27 | 27 | 25 | 25 | 20 | 26 | 26 | 26 |
| D2 | 1 | 1 | 1 | 1 | 1 | 1 | 1 | 1 |
| D3 | 0.5 | 0.5 | 0.5 | 0.5 | 0.5 | 0.5 | 0.5 | 0.5 |
| D4 | — | — | — | — | — | 6 | 6 | 6 |
| LOI [%] | 26 | 28 | 31 | 32 | 26 | — | — | — |
| UL 94 | — | — | — | — | — | V-0 | V-2 | V-0 |
| [0.8 mm] | | | | | | | | |
| burning drops | — | — | — | — | — | + | + | □ |

comp = for comparison

1-8. (canceled)

9. A thermoplastic molding composition, comprising
A) from 10 to 98% by weight of a thermoplastic polymer,
B) from 0.5 to 40% by weight of a flame retardant compound comprising phosphorus,
C) from 0.5 to 35% by weight of iron sulfide,
D) from 0 to 70% by weight of further additives,
where the total of the percentages by weight of components A) to D) does not exceed 100%.

10. The thermoplastic molding composition according to claim 9, comprising FeS₂ as component C).

11. The thermoplastic molding composition according to claim 9, comprising from 1 to 50% by weight of a fibrous or particulate filler as component D).

12. The thermoplastic molding composition according to claim 9, in which the sulfur content, based on elemental sulfur, of component C) is at least 35%.

13. The thermoplastic molding composition according to claim 9, in which the d₉₀ value (primary particle size) of component C) is <1000 μm.

14. The thermoplastic molding composition according to claim 10, comprising from 1 to 50% by weight of a fibrous or particulate filler as component D).

15. The thermoplastic molding composition according to claim 14, in which the sulfur content, based on elemental sulfur, of component C) is at least 35%.

16. The thermoplastic molding composition according to claim 15, in which the d₉₀ value (primary particle size) of component C) is <1000 μm.

17. The thermoplastic molding composition according to claim 9, in which component B) is composed of red phosphorus, of melamine polyphosphate, or of phosphinic salts of the formula (I), or/and of diphosphinic salts of the formula (II), or of polymers of these 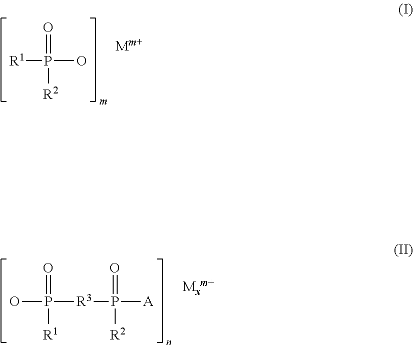
in which
R¹ and R² are identical or different, being hydrogen, C₁-C₆-alkyl, linear or branched, and/or aryl;
R³ is C₁-C₁₀-alkylene, linear or branched, or C₆-C₁₀-arylene, -alkylarylene, or -arylalkylene;
M is Mg, Ca, Al, Sb, Sn, Ge, Ti, Zn, Fe, Zr, Ce, Bi, Sr, Mn, Li, Na, K, or a protonated nitrogen base or a mixture thereof;
m is from 1 to 4; n is from 1 to 4; x is from 1 to 4.

18. The thermoplastic molding composition according to claim 16, in which component B) is composed of red phosphorus, of melamine polyphosphate, or of phosphinic salts of the formula (I), or/and of diphosphinic salts of the formula (II), or of polymers of these 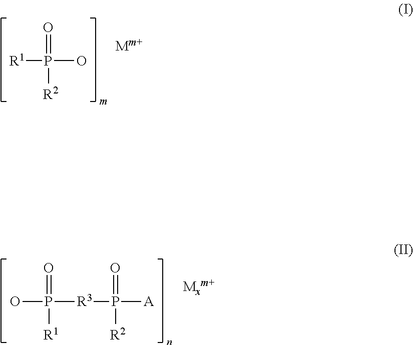
in which
R¹ and R² are identical or different, being hydrogen, C₁-C₆-alkyl, linear or branched, and/or aryl;
R³ is C₁-C₁₀-alkylene, linear or branched, or C₆-C₁₀-arylene, -alkylarylene, or -arylalkylene;
M is Mg, Ca, Al, Sb, Sn, Ge, Ti, Zn, Fe, Zr, Ce, Bi, Sr, Mn, Li, Na, K, or a protonated nitrogen base or a mixture thereof;
m is from 1 to 4; n is from 1 to 4; x is from 1 to 4.

19. A fiber, foil, or molding obtainable from the thermoplastic molding compositions according to claim 9.

20. A fiber, foil, or molding obtainable from the thermoplastic molding compositions according to claim 18.
